(19) United States
(12) Patent Application Publication
(10) Pub. No.: US 2025/0102059 A1
(43) Pub. Date: Mar. 27, 2025

(54) COOLING AND LUBRICATION APPARATUS OF ELECTRICAL DRIVE ASSEMBLY AND ELECTRICAL DRIVE ASSEMBLY

(71) Applicant: Jing-Jin Electric Technologies Co., Ltd., Beijing (CN)

(72) Inventors: Jianwen LI, Beijing (CN); Yang LIU, Beijing (CN); Fayu PAN, Beijing (CN)

(21) Appl. No.: 18/294,667

(22) PCT Filed: May 16, 2022
(86) PCT No.: PCT/CN2022/093089

§ 371 Date: Feb. 2, 2024

(30) Foreign Application Priority Data
Aug. 3, 2021 (CN) 202110887039.X

(51) Int. Cl. F16H 57/04

(52) U.S. Cl. CPC F16H 57/0476; F16H 57/0404; F16H 57/0415; F16H 57/0421; F16H 57/0439

(57) ABSTRACT

A cooling and lubrication device of an electric drive assembly and an electric drive assembly are disclosed. The cooling and lubrication device includes an oil pumping unit, an oil pumping passage, and an oil returning passage. Outlets of oil distribution passages correspond to parts to be cooled and parts to be lubricated inside the motor housing, as well as parts to be cooled and parts to be lubricated. The oil pumping unit pumps the lubricating oil inside the first housing into the oil pumping passage, and transfers the lubricating oil to the parts to be cooled and the parts to be lubricated. The oil returning passage allows the lubricating oil inside the second housing to flow back into the first housing. This cooling and lubrication device can achieve active and directional cooling and lubrication of the parts to be cooled and the parts to be lubricated.

### CROSS REFERENCING OF RELATED APPLICATIONS

This application claims priority from the Chinese patent application No. 202110887039.X filed with the Chinese Patent Office on Aug. 3, 2021 and entitled “COOLING AND LUBRICATION APPARATUS OF ELECTRICAL DRIVE ASSEMBLY AND ELECTRICAL DRIVE ASSEMBLY”, the content of which is hereby incorporated by reference in its entirety.

### TECHNICAL FIELD

The present disclosure belongs to the technical field of cooling and lubrication of an electric drive assembly, and particularly relates to a cooling and lubrication device of an electric drive assembly and an electric drive assembly.

### BACKGROUND

With the continuous development of new energy vehicles, the requirements for their safety, power, energy consumption, noise and other related performance are becoming increasingly high. In order to adapt to various complex road conditions, the electric drive assembly of automobiles needs to have technical characteristics such as high power, high torque, high speed, and high efficiency. At the same time, higher demands are put forward for the lubrication and cooling of the motor and reducer in the electric drive assembly.

At present, the lubrication and cooling of the reducer of the electric drive assembly in automobiles are usually realized by stirring the lubricating oil inside the housing with a gear to make it splash. The lubricating oil of the reducer flows or splashes to friction pairs of rotating parts such as gears, bearings, and oil seals for passive lubrication. The lubricating oil flows and takes away the heat generated during the operation of the rotating parts, thereby achieving passive cooling. However, this passive splash lubrication and cooling method cannot provide sufficient lubrication and timely removal of the large amount of heat generated by the reducer during high speed and high torque output. In addition, the cooling of motor is realized by making the coolant flow through the water passage on the stator housing to take away the heat generated during the operation of the motor. This conventional cooling method can only reduce or stabilize the temperature at a local area of the motor. However, the temperature of the motor coil and rotor inside the motor is much higher than the temperature of the stator. Due to the limitations of the motor structure and conventional cooling methods, the heat generated by the motor under long-term, high power, high torque, high speed operating conditions cannot be fully and quickly taken away.

### SUMMARY

With respect to the above problems, the present disclosure provides a cooling and lubrication device of an electric drive assembly and an electric drive assembly in order to overcome or at least partially solve the above problems.

In order to achieve the above object, the present disclosure adopts the following technical solutions.

An aspect of the present disclosure provides a cooling and lubrication device of an electric drive assembly. The electric drive assembly comprises a motor unit and a reducer unit, the motor unit comprises a motor housing, and the reducer unit comprises a reducer housing;

the cooling and lubrication device comprises an oil pumping unit, an oil pumping passage, and an oil returning passage;

the oil pumping passage comprises several oil distribution passages, and positions of outlets of oil distribution passages correspond to parts to be cooled and parts to be lubricated inside the motor housing, as well as parts to be cooled and parts to be lubricated inside the reducer housing;

the oil pumping unit comprises an oil inlet and an oil outlet, the oil inlet is communicated with a first housing, the oil outlet is communicated with the oil pumping passage, and the oil pumping unit is used to pump the lubricating oil inside the first housing into the oil pumping passage, and transfer the lubricating oil to the parts to be cooled and the parts to be lubricated through the oil distribution passages;

the oil returning passage is provided at the bottom of a second housing to allow the lubricating oil inside the second housing to flow back into the first housing;

the first housing is the motor housing, and the second housing is the reducer housing; alternatively, the first housing is the reducer housing, and the second housing is the motor housing.

Further, the cooling and lubrication device further comprises an oil filtering unit:

the oil filtering unit is provided at the bottom of the first housing and used to filter the lubricating oil.

Further, the oil filtering unit is a detachable oil filter.

Further, the cooling and lubrication device further comprises a cooler unit;

the cooler unit is provided on an oil passage between the oil pumping unit and the oil filtering unit or between the oil filtering unit and the first housing, and is used to cool the lubricating oil inside the oil passage.

Further, the oil pumping unit comprises a mechanical oil pump;

the mechanical oil pump is provided inside the reducer housing and is connected to the reducer unit for transmission.

Further, the reducer unit further comprises an intermediate shaft;

the mechanical oil pump is connected to the intermediate shaft for transmission. Further, the oil pumping unit comprises an electronic oil pump and an electronic control unit;

the electronic oil pump is provided at a bottom of the motor housing or the reducer housing, and the electronic control unit is used to control operation of the electronic oil pump.

Further, the oil pumping unit further comprises several temperature sensors;

the temperature sensors are provided inside the motor housing and/or the reducer housing, and the electronic control unit controls operation of the electronic oil pump based on a temperature detected by the temperature sensors.

Further, the oil pumping unit further comprises a rotational speed sensor;

the rotational speed sensor is used to detect a rotational speed of a motor or a reducer and transfer the detected rotational speed to the electronic control unit, and the electronic control unit controls operation of the electronic oil pump based on the rotational speed of the motor or the reducer.

Another aspect of the present disclosure provides an electric drive assembly. The electric drive assembly uses any of the cooling and lubrication devices as described above for cooling and lubrication of the motor and the reducer.

The advantages and beneficial effects of the present disclosure are as follows.

In the cooling and lubrication device of the present disclosure, by providing the oil pumping unit and several oil distribution passages, and making the positions of outlets of oil distribution passages respectively correspond to the parts to be cooled and the parts to be lubricated inside the motor housing as well as the parts to be cooled and the parts to be lubricated inside the reducer housing, the lubricating oil is pumped into the oil pumping passage from the reducer housing or the motor housing by the oil pumping unit, and transferred to the parts to be cooled and the parts to be lubricated through the oil distribution passages, thereby achieving active and directional cooling and lubrication of the parts to be cooled and the parts to be lubricated. The cooling and lubrication efficiency is higher Moreover, the cooling and lubrication device realizes the integration of cooling and lubrication of the motor and the reducer, thereby making the electric drive assembly structure more compact.

### BRIEF DESCRIPTION OF DRAWINGS

By reading the detailed description of the preferred embodiments below, various other advantages and benefits will become clear to a person of ordinary skill in the art. The accompanying drawings are only used for the purpose of illustrating the preferred embodiments, and should not be considered as a limitation to the present disclosure. Moreover, throughout the drawings, the same reference numerals are used to denote the same components. In the drawings:

FIG. 1 is a schematic diagram of the structure of a cooling and lubrication device of an electric drive assembly according to an embodiment of the present disclosure; and

FIG. 2 is a schematic diagram of the structure of another cooling and lubrication device of an electric drive assembly according to an embodiment of the present disclosure.

In the drawings: 1. oil distribution passage; 2. oil inlet; 3. oil outlet; 4. oil passage; 5. intermediate shaft.

### DETAILED DESCRIPTION

In order to make the object, technical solutions, and advantages of the present disclosure clearer, the present disclosure will be described clearly and completely in conjunction with the specific embodiments and corresponding drawings. Obviously, the embodiments described are only part of rather than all of the embodiments of the present disclosure. Based on the embodiments in the present disclosure, all other embodiments obtained by a person of ordinary skill in the art without paying creative work shall fall within the protection scope of the present disclosure.

The technical solutions provided in embodiments of the present disclosure will be explained in detail below in conjunction with the accompanying drawings.

In an embodiment of the present disclosure, a cooling and lubrication device of an electric drive assembly is disclosed. The electric drive assembly comprises a motor unit and a reducer unit, the motor unit comprises a motor housing, the reducer unit comprises a reducer housing, and the reducer housing is provided at a rear end of the motor housing. The cooling and lubrication device comprises an oil pumping unit, an oil pumping passage, and an oil returning passage.

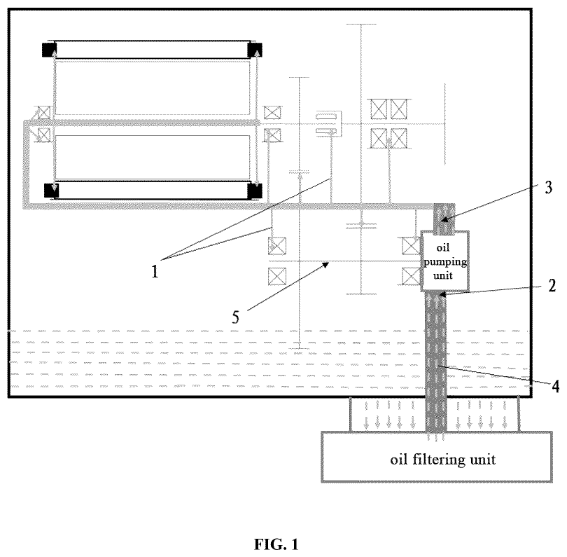

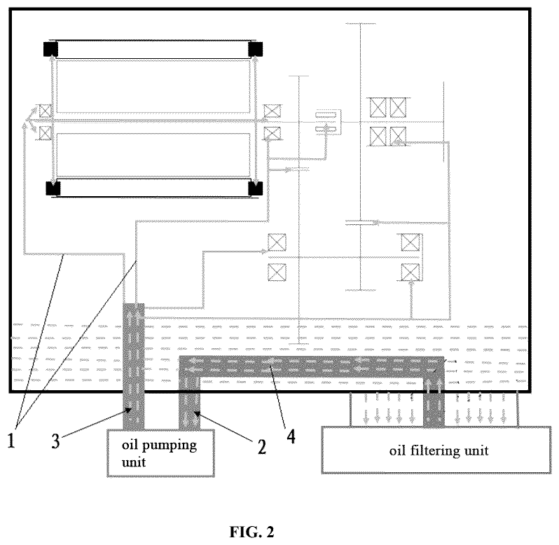

As shown in FIGS. 1 to 2, the oil pumping passage comprises several oil distribution passages 1. The oil distribution passages 1 may be oil pipes or oil paths. When the oil distribution passage 1 is an oil path, the oil path may be directly formed by casting on the motor housing and the reducer housing. The positions of outlets of oil distribution passages 1 correspond respectively to the parts to be cooled and the parts to be lubricated inside the motor housing as well as the parts to be cooled and the parts to be lubricated inside the reducer housing.

The oil pumping unit comprises an oil inlet 2 and an oil outlet 3. The oil inlet 2 is communicated with a first housing, so that the lubricating oil in the first housing can enter the oil pumping unit through the oil inlet 2. The oil outlet 3 is communicated with the oil pumping passage. The oil pumping unit pumps the lubricating oil in the first housing into the oil pumping passage and transfers it to the parts to be cooled and the parts to be lubricated through the oil distribution passages 1, thereby achieving targetedly cooling of the parts to be cooled and lubrication of the parts to be lubricated. The parts to be cooled include bearings, gears, motor coils, motor rotors, etc. The parts to be lubricated include bearings, gears, oil seals, etc.

For example, the positions of outlets of one or more oil distribution passages 1 correspond to the motor coil, thereby achieving directional and active cooling of the motor coil by lubricating oil, timely and quickly removing the heat generated during the operation of the motor coil, avoiding or reducing early failure of the entire vehicle due to the high working temperature of the motor under special working conditions, and improving the power density and overall efficiency of the motor.

The oil returning passage is provided at the bottom of the second housing, so that the lubricating oil inside the second housing can flow back into the first housing.

The first housing is the motor housing, and the second housing is the reducer housing. Alternatively, the first housing is the reducer housing, and the second housing is the motor housing. The height of a bottom of the first housing is lower than the height of a bottom of the second housing.

When the first housing is the reducer housing and the second housing is the motor housing, the flow path of lubricating oil inside the reducer housing is as follows. The lubricating oil at the bottom of the reducer housing is pumped into the oil pumping passage through the oil pumping unit, and then transferred to the parts to be cooled and the parts to be lubricated inside the reducer housing through oil distribution passages 1. After completing lubrication and cooling, the lubricating oil returns to the bottom of the reducer housing due to gravity. The flow path of lubricating oil inside the motor housing is as follows. The lubricating oil at the bottom of the reducer housing is pumped into the oil pumping passage through the oil pumping unit, and then transferred to the parts to be cooled and the parts to be lubricated inside the motor housing through oil distribution passages 1. After completing lubrication and cooling, the lubricating oil returns to the bottom of the motor housing due to gravity, and finally returns to the reducer housing through the oil returning passage.

In sum, in the cooling and lubrication device of this embodiment, by providing the oil pumping unit and several oil distribution passages, and making the positions of outlets of oil distribution passages respectively correspond to the parts to be cooled and the parts to be lubricated inside the motor housing as well as the parts to be cooled and the parts to be lubricated inside the reducer housing, the lubricating oil is pumped into the oil pumping passage from the reducer housing or the motor housing by the oil pumping unit, and transferred to the parts to be cooled and the parts to be lubricated through the oil distribution passages, thereby achieving active and directional cooling and lubrication of the parts to be cooled and the parts to be lubricated. The cooling and lubrication efficiency is higher. The cooling and lubrication device can meet the cooling and lubrication needs of the vehicle electric drive assembly that works with long-term, high power, high torque, high speed under various working conditions, and increases the reliability of the vehicle. Moreover, the cooling and lubrication device realizes the integration of cooling and lubrication of the motor and the reducer, thereby making the electric drive assembly structure more compact and less space-occupying.

In an embodiment, as shown in FIGS. 1 to 2, the cooling and lubrication device further comprises an oil filtering unit.

The oil filtering unit is provided at the bottom of the first housing for filtering lubricating oil. Before entering the oil pumping unit, the lubricating oil inside the first housing can be filtered by the oil filtering unit to remove particles in the lubricating oil, prevent the particles from blocking the oil distribution passage 1 and affecting the normal operation of the motor and the reducer. The oil filtering unit is provided at the bottom of the first housing, which can not only fully utilize the space at the bottom of the first housing, but also allow the lubricating oil at the bottom of the first housing to enter the oil filtering unit for filtration under the action of gravity.

Furthermore, in order to prevent the deterioration of filtration effect of the oil filtering unit caused by long-term use, the oil filtering unit may be a detachable oil filter, and the filtration effect of the oil filtering unit can be ensured by replacing a filter element.

In an embodiment, in order to further enhance the cooling effect on the electric drive assembly, the cooling and lubrication device further comprises a cooler unit.

The cooler unit is provided on the oil passage 4 that is between the oil pumping unit and the oil filtering unit or between the oil filtering unit and the first housing, and is used to cool the lubricating oil inside the oil passage 4. Circulating coolant can be provided inside the cooler unit, and the heat exchange between the lubricating oil in passage 4 and the coolant is achieved through the cooler unit, taking away the heat inside the electric drive assembly and further improving the heat dissipation performance of the electric drive assembly.

In an embodiment, the oil pumping unit comprises a mechanical oil pump.

The mechanical oil pump is provided inside the reducer housing and connected to the reducer unit for transmission. When the reducer rotates, it can directly drive the mechanical oil pump to work without need for an additional control unit. The cost of the mechanical oil pump is also low.

In an embodiment, as shown in FIG. 1, the reducer unit further comprises an intermediate shaft 5.

The mechanical oil pump is connected to the intermediate shaft 5 for transmission, and the rotational speed of the mechanical oil pump is controlled through the intermediate shaft 5.

In an or some embodiments, the oil pumping unit comprises an electronic oil pump and an electronic control unit.

The electronic oil pump is provided at the bottom of the motor housing or the reducer housing to save space, and the electronic control unit can control the operation of the electronic oil pump as needed.

In an or some embodiments, the oil pumping unit further comprises several temperature sensors.

The temperature sensors are provided inside the motor housing and/or the reducer housing, and transfer the detected temperatures to the electronic control unit. The electronic control unit controls the operation of the electronic oil pump based on the temperatures detected by the temperature sensors. For example, a temperature sensor is provided at the motor coil to detect the temperature of the motor coil. When the temperature of the motor coil reaches a certain value, the control unit controls the electronic oil pump to pump the lubricating oil to the motor coil, thereby achieving the cooling of the motor coil.

In an or some embodiments, the oil pumping unit further comprises a rotational speed sensor.

The rotational speed sensor is used to detect the rotational speed of the motor or the reducer, and transfers the detected speed to the electronic control unit. The electronic control unit controls the operation of the electronic oil pump based on the rotational speed of the motor or the reducer. Namely, when the rotational speed of the motor or the reducer exceeds a preset value, the electronic control unit controls the electronic oil pump to work, thereby achieving the cooling and lubrication of the electric drive assembly.

In an embodiment of the present disclosure, an electric drive assembly is disclosed. The electric drive assembly uses the cooling and lubrication device as describe in any of the above embodiments for cooling and lubrication of the motor and the reducer. The electric drive assembly has the advantages of good cooling and lubrication performance, and can achieve high torque and high rotational speed output.

The above merely describes particular embodiments of the present disclosure. By the teaching of the present disclosure, a person skilled in the art can make other modifications or variations based on the above embodiments. A person skilled in the art should appreciate that, the detailed description above is only for the purpose of better explaining the present disclosure, and the protection scope of the present disclosure should be subject to the protection scope of the claims.

1. A cooling and lubrication device of an electric drive assembly, wherein the electric drive assembly comprises a motor unit and a reducer unit, the motor unit comprises a motor housing, and the reducer unit comprises a reducer housing, characterized in that
the cooling and lubrication device comprises an oil pumping unit, an oil pumping passage, and an oil returning passage;
the oil pumping passage comprises several oil distribution passages, and positions of outlets of oil distribution passages correspond to parts to be cooled and parts to be lubricated inside the motor housing, as well as parts to be cooled and parts to be lubricated inside the reducer housing;
the oil pumping unit comprises an oil inlet and an oil outlet, the oil inlet is communicated with a first housing, the oil outlet is communicated with the oil pumping passage, and the oil pumping unit is used to pump the lubricating oil inside the first housing into the oil pumping passage, and transfer the lubricating oil to the parts to be cooled and the parts to be lubricated through the oil distribution passages;
the oil returning passage is provided at the bottom of the second housing to allow the lubricating oil inside the second housing to flow back into the first housing;
the first housing is the motor housing, and the second housing is the reducer housing; alternatively, the first housing is the reducer housing, and the second housing is the motor housing.

2. The cooling and lubrication device according to claim 1, wherein the cooling and lubrication device further comprises an oil filtering unit; and
the oil filtering unit is provided at the bottom of the first housing and used to filter the lubricating oil.

3. The cooling and lubrication device according to claim 2, wherein the oil filtering unit is a detachable oil filter.

4. The cooling and lubrication device according to claim 2, wherein the cooling and lubrication device further comprises a cooler unit; and
the cooler unit is provided on an oil passage between the oil pumping unit and the oil filtering unit or between the oil filtering unit and the first housing, and is used to cool the lubricating oil inside the oil passage.

5. The cooling and lubrication device according to claim 1, wherein the oil pumping unit comprises a mechanical oil pump; and
the mechanical oil pump is provided inside the reducer housing and is connected to the reducer unit for transmission.

6. The cooling and lubrication device according to claim 5, wherein the reducer unit further comprises an intermediate shaft; and
the mechanical oil pump is connected to the intermediate shaft for transmission.

7. A cooling and lubrication device according to claim 1, wherein the oil pumping unit comprises an electronic oil pump and an electronic control unit; and
the electronic oil pump is provided at a bottom of the motor housing or the reducer housing, and the electronic control unit is used to control operation of the electronic oil pump.

8. The cooling and lubrication device according to claim 7, wherein the oil pumping unit further comprises several temperature sensors; and
the temperature sensors are provided inside the motor housing and/or the reducer housing, and the electronic control unit controls operation of the electronic oil pump based on a temperature detected by the temperature sensors.

9. The cooling and lubrication device according to claim 7, wherein the oil pumping unit further comprises a rotational speed sensor; and
the rotational speed sensor is used to detect a rotational speed of a motor or a reducer and transfer a detected rotational speed to the electronic control unit, and the electronic control unit controls operation of the electronic oil pump based on the rotational speed of the motor or the reducer.

10. An electric drive assembly using the cooling and lubrication device according to claim 1 for cooling and lubrication of the motor and the reducer.

11. A cooling and lubrication device according to claim 2, wherein the oil pumping unit comprises an electronic oil pump and an electronic control unit; and
the electronic oil pump is provided at a bottom of the motor housing or the reducer housing, and the electronic control unit is used to control operation of the electronic oil pump.

12. A cooling and lubrication device according to claim 3, wherein the oil pumping unit comprises an electronic oil pump and an electronic control unit; and
the electronic oil pump is provided at a bottom of the motor housing or the reducer housing, and the electronic control unit is used to control operation of the electronic oil pump.

13. A cooling and lubrication device according to claim 4, wherein the oil pumping unit comprises an electronic oil pump and an electronic control unit; and
the electronic oil pump is provided at a bottom of the motor housing or the reducer housing, and the electronic control unit is used to control operation of the electronic oil pump.

14. A cooling and lubrication device according to claim 5, wherein the oil pumping unit comprises an electronic oil pump and an electronic control unit; and
the electronic oil pump is provided at a bottom of the motor housing or the reducer housing, and the electronic control unit is used to control operation of the electronic oil pump.

15. A cooling and lubrication device according to claim 6, wherein the oil pumping unit comprises an electronic oil pump and an electronic control unit; and
the electronic oil pump is provided at a bottom of the motor housing or the reducer housing, and the electronic control unit is used to control operation of the electronic oil pump.

16. An electric drive assembly using the cooling and lubrication device according to claim 2 for cooling and lubrication of the motor and the reducer.

17. An electric drive assembly using the cooling and lubrication device according to claim 5 for cooling and lubrication of the motor and the reducer.

18. An electric drive assembly using the cooling and lubrication device according to claim 7 for cooling and lubrication of the motor and the reducer.

19. An electric drive assembly using the cooling and lubrication device according to claim 8 for cooling and lubrication of the motor and the reducer.

20. An electric drive assembly using the cooling and lubrication device according to claim 9 for cooling and lubrication of the motor and the reducer.
